(19) United States
(12) Patent Application Publication
(10) Pub. No.: US 2019/0228240 A1
(43) Pub. Date: Jul. 25, 2019

(54) METHOD FOR DETECTING GARAGE PARKING SPACES

(71) Applicant: VALEO Schalter und Sensoren GmbH, Bietigheim-Bissingen (DE)

(72) Inventors: Evangelos Stamatopoulos, Bietigheim-Bissingen (DE); Gabriel Schoenung, Bietigheim-Bissingen (DE)

(73) Assignee: VALEO Schalter und Sensoren GmbH, Bietigheim-Bissingen (DE)

(21) Appl. No.: 16/256,386

(22) Filed: Jan. 24, 2019

(30) Foreign Application Priority Data
Jan. 24, 2018 (DE) 102018101513.5

(51) Int. Cl. G06K 9/00; B60W 30/06; G08G 1/14; G06F 16/29; G06T 17/05

(52) U.S. Cl. CPC G06K 9/00812; B60W 30/06; G06T 17/05; G06F 16/29; G08G 1/143

(57) ABSTRACT

A method for detecting garage parking spaces for vehicles (1) in an area surrounding a vehicle (1) using a parking assistance system (2), wherein the vehicle (1) has at least one environment sensor (8, 10, 11, 12, 13, 14, 15), is designed such that garage parking spaces in a garage (20) can be reliability detected. This is achieved by providing a method comprising the steps of receiving sensor data using the parking assistance system (2) from the at least one environment sensor (8, 10, 11, 12, 13, 14, 15) from the surrounding area, transmission of sensor data to an on-board computer unit (6), creating a digital environment map of the surrounding area from the sensor data, detection of a parking space-like subregion (21) of the surrounding area in the environment map, classifying the parking space-like subregion (21) as a garage parking space by means of deep learning models. The invention also relates to a parking assistance system (2), for a vehicle (1) to support a driver of a motor vehicle when parking in a parking space, in particular in a garage (20), and to a vehicle (1) having such a parking assistance system (2).

The present invention relates to a method for detecting garage parking spaces for vehicles in an area surrounding a vehicle. The invention also relates to a parking assistance system for carrying out such a method. The present invention further relates to a vehicle with a parking assistance system.

Parking assistance systems for motor vehicles already exist in the prior art. They are used to assist the driver when parking a vehicle in a parking space and, possibly also when driving out of the parking space. In parking assistance systems which are designed for the semi-autonomous or fully automatic parking in a garage, a particular challenge is to detect the garage automatically using the parking assistance system. The parking assistance system should be able to detect the garage as a target position of the vehicle, without the driver needing to make a special input. The parking assistance system is therefore designed to be able to detect a scenario in which the driver can park the car in front of the garage or in the vicinity of the garage. An essential object of the parking assistance system is the recognition of a parking space in the garage itself. Parking assistance systems receive input from multiple data sources, such as the on-board image capture system, image processing, radar sensors, lidar, ultrasonic sensors and other sources.

Common to all these system types is that, on the basis of collected environment information, the parking assistance system can detect the parking space and determine the current position of the motor vehicle relative to the parking space. Depending on the current position of the motor vehicle, the system then calculates a parking trajectory suitable for the parking process, along which the motor vehicle is driven either automatically or semi-autonomously into the target position in the parking space without collisions. The collection of environment information takes place by means of sensors, wherein a wide variety of sensor technologies can be combined together to create a digital environment map, which contains the necessary information about the garage layout. Based on the garage layout, the parking assistance system detects the parking space. The garage layout can consist, for example, of the side walls of the garage and the rear wall. This information is considered to be sufficient for the activation of the garage parking manoeuvre. The system cannot ensure, however, that the garage layout that is provided also relates to a parking space in the garage. This is due to the fact that a similar interpretation can be obtained in the event of a parking space which is suitable for right-angled parking.

DE 10 2012 022 336 A1 discloses a method for performing an at least semi-autonomous parking operation of a motor vehicle in a parking garage, wherein the garage is detected by means of a parking assistance system of the motor vehicle and a current position of the motor vehicle is determined relative to the garage, and wherein after detection of the garage the at least semi-autonomous parking operation is performed depending on the current position of the motor vehicle relative to the garage, wherein an image of the garage is captured by means of a camera of the parking assistance system and the detection of the garage comprises the fact that by means of an image processing device of the parking assistance system the image is subjected to a pattern recognition process with regard to a garage entrance and the garage is identified by means of the pattern recognition.

Currently the garage parking function must often be launched manually by the driver, since a garage parking space has not been detected unambiguously. In future, however, a more advanced system will be able to accurately identify a garage parking space and activate the garage parking function accordingly.

On the basis of the above-mentioned prior art, the object of the invention is therefore to demonstrate a solution to the problem of how a garage can be reliably detected in a method for detecting garage parking spaces.

The object is achieved according to the invention by means of the features of the independent claims. Advantageous designs of the invention are described in the dependent claims.

According to the invention therefore, a method is specified for detecting garage parking spaces for vehicles in an area surrounding a vehicle using a parking assistance system, wherein the vehicle has at least one environment sensor, comprising the steps: reception of sensor data using the parking assistance system by the at least one environment sensor from the surrounding area, transmission of the sensor data to an on-board computer unit, creating a digital environment map of the surrounding area from the sensor data, detection of a parking space-like subregion of the surrounding area in the environment map, classifying the parking space-like subregion as a garage parking space by means of deep learning models.

The basic idea of the present invention, therefore, is to enable the classification of garage parking spaces on the basis of sensor data by means of deep learning models. In deep learning a computer model learns to perform classification tasks directly from the sensor data provided. Deep learning is achieving higher levels of accurate detection than ever before, which is increasing the accuracy of the recognition of the parking space-like subregion as a garage parking space.

In an advantageous design of the invention, a model for the garage parking space is used and missing parameters of the model are supplemented by means of the sensor data using the deep learning model, thus enabling a classification of the parking space-like subregion as a garage parking space.

In a further advantageous design of the invention the deep learning model is pre-trained for the classification of garage parking spaces, wherein the pre-training of the deep learning model is carried out by accessing data from a database or by on-board recording of sensor data.

In an advantageous design of the invention, the pre-training of the deep learning model is carried out online or offline. In the online mode (“online”) the deep learning model can access data from a database which is already filled with sensor data that has been sent by other vehicles, for example by development vehicles, to a cloud via a mobile network. The actual learning process of the deep learning model after the input of this sensor data can also be carried out in the offline mode (“offline”). The sensor data in this database are preferably manually tagged or annotated. The pre-training of the deep learning model can also be carried out by on-board recording of sensor data, which can then preferably be used in the offline mode for learning or pre-training of the deep learning model.

In a further advantageous design of the invention the deep learning model comprises a neural network, in particular a deep neural network (DNN). It is advantageous if the deep learning model uses architectures in the form of neural networks. If such a deep learning model uses a neural network, it is also referred to as a deep neural network (DNN). It is more advantageous if the deep neural network (DNN) is a convolutional neural network (CNN). A CNN convolves learned features with input data using 2D convolution planes, which makes this architecture suitable for processing 2D data such as images. CNNs make manual feature extraction unnecessary. This means that they do not have to identify features that are used for the classification of images. The CNN works by extracting features directly from images. The relevant features are not pre-trained but are learned while the network is trained on the basis of a large set of images. As a result of this automated feature extraction, deep learning models are ideally suited for computer vision tasks such as object classification.

In an advantageous design of the invention the step of receiving sensor data with the at least one environment sensor comprises receiving environment sensor data of at least one on-board environment sensor, in particular receiving ultrasonic sensor data and/or radar sensor data and/or lidar data, with the parking assistance system.

In a further advantageous design of the invention, the step of receiving sensor data with the at least one environment sensor comprises receiving image data from one or more images and/or video sequences using at least one camera system comprising one or more cameras, using the parking assistance system.

In an advantageous design of the invention the creation of a digital environment map of the surrounding area from the sensor data comprises creating a three-dimensional environment map. In addition to the detection of a parking space-like subregion, the recognition of a ceiling from a three-dimensional environment map can confirm the presence of a garage.

In a further advantageous design of the invention, the classification of the parking space-like subregion as a garage parking space comprises using a position signal. The combination of the environment sensor data and the digital environment map of the surrounding area with position data has the advantage that it is then possible to ensure that the recognised parking space-like subregion belongs to a garage and not to another type of parking space. The position signal can be provided, for example, by the well-known satellite navigation systems such as GPS, Galileo, GLONASS or Beidou.

In an advantageous design of the invention, for the classification of the parking space-like subregion as a garage parking space a vehicle-to-infrastructure communication is used, wherein the vehicle communicates directly with the garage. The direct communication of the parking assistance system with the infrastructure of the garage enables the parking assistance system to detect that the vehicle is situated in an area in front of the garage. By combining this information with the information generated by the digital environment map, the detection of garage parking spaces is further improved.

In a further advantageous design of the invention it is provided that an additional step comprises the automatic activation of the parking assistance system as soon as the parking space-like subregion has been classified as a garage parking space.

In an advantageous design of the invention the method comprises an additional step for automatically activating a parking assistance system as soon as the parking space-like subregion has been classified as a garage parking space. A manual activation, for example, by the driver is therefore no longer necessary.

In a further advantageous design of the invention, the parking into the garage is carried out autonomously by the parking assistance system.

In a further advantageous design of the invention a size of the free space available for parking in the garage is determined.

In addition to the detection of a parking space-like subregion as a garage parking space, additional information about the garage parking space can be collected. For example, by determining the available free space it is possible to determine whether the vehicle will fit into the garage.

The invention also provides a parking assistance system for a vehicle to assist a driver of a motor vehicle when parking in a parking space, in particular in a garage, comprising at least one environment sensor configured for receiving sensor data from the surrounding area of the vehicle, and an on-board computer unit, which is configured for receiving the sensor data and for creating a digital environment map of the surrounding area based on/using the sensor data, wherein the computer unit is also configured for detecting a parking space-like subregion of the surrounding area in the environment map and for classifying the parking space-like subregion as a garage parking space by means of deep learning models.

The invention also provides a computer program product for carrying out the method according to the invention.

The invention also relates to a vehicle having the parking assistance system according to the invention. The vehicle system may, in particular, be a passenger car.

In the following, the invention is described in greater detail with reference to the attached drawings and based on preferred embodiments. The features described can represent an aspect of the invention both individually and in combination. Features of different exemplary embodiments are transferable from one exemplary embodiment to another.

Shown are:

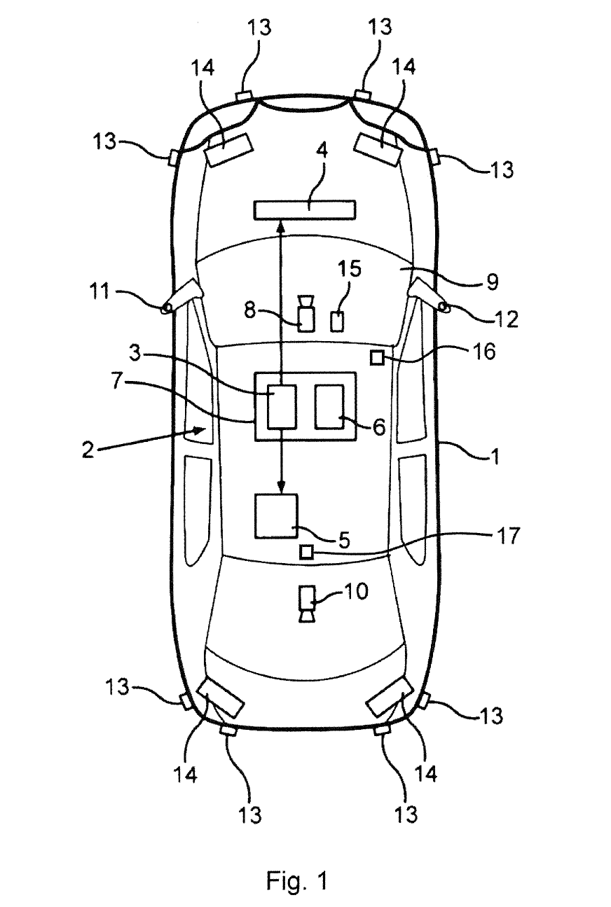

FIG. 1 a schematic view of a motor vehicle with a parking assistance system according to a preferred embodiment of the invention;

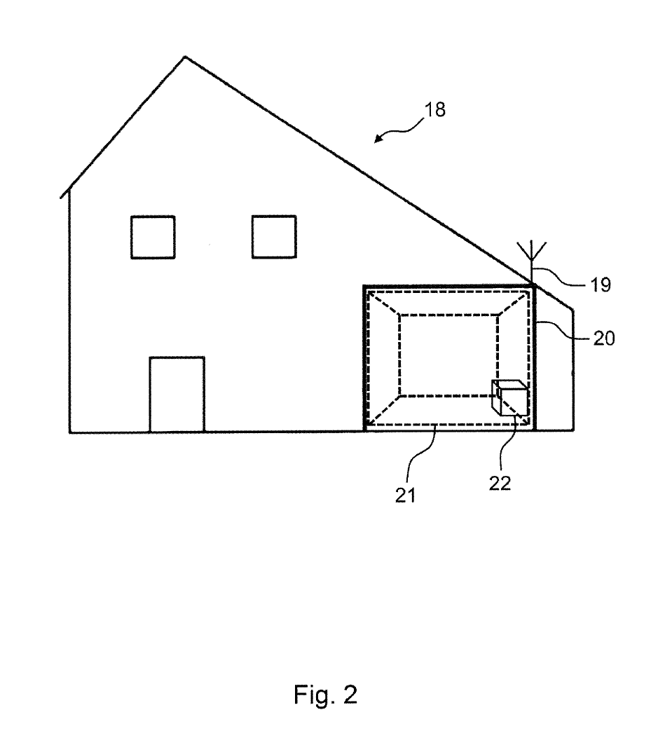

FIG. 2 a schematic view of a building with a garage;

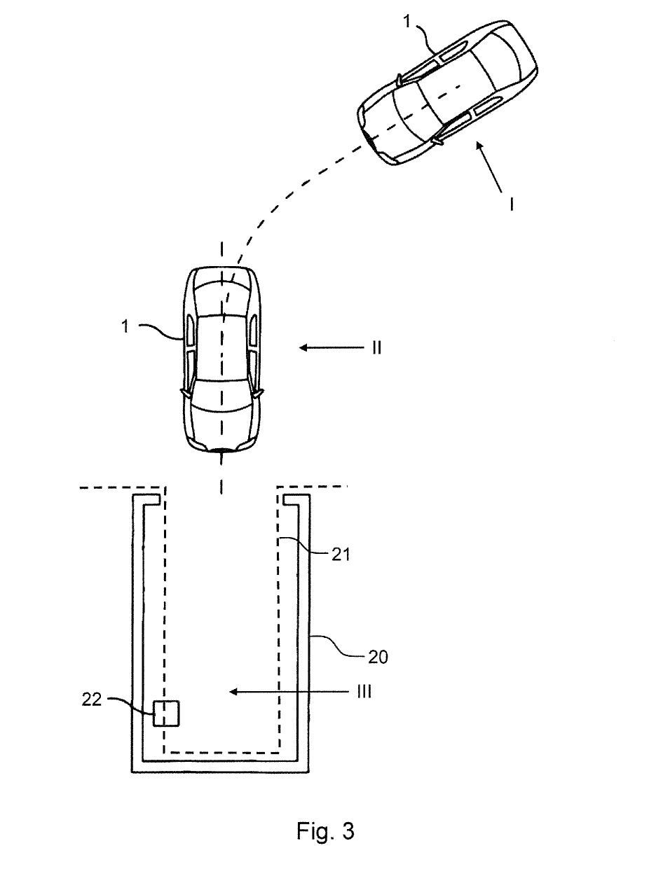

FIG. 3 a schematic representation of a plan view of a parking scenario; and

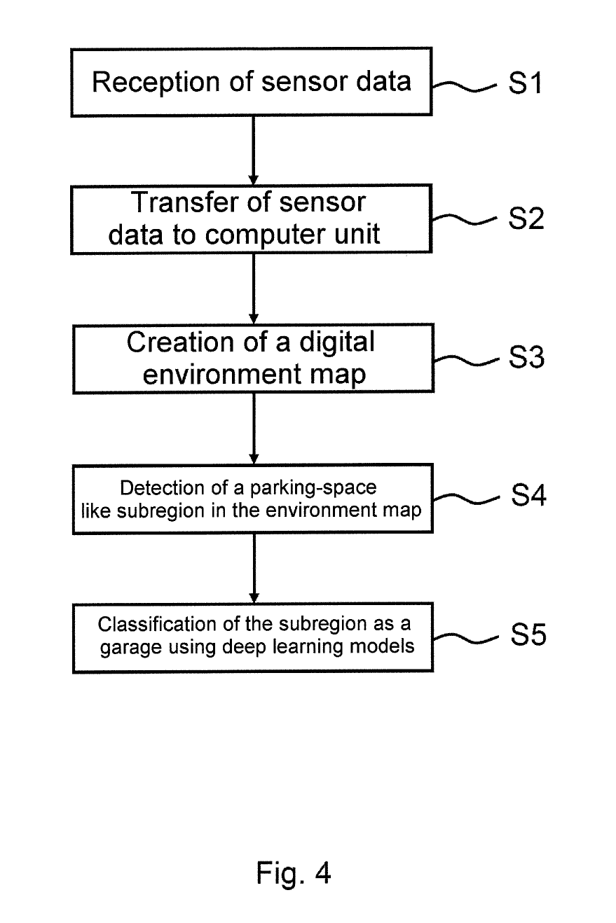

FIG. 4 a simplified schematic flow diagram of an embodiment of the method according to the invention.

FIG. 1 shows a schematic view of a motor vehicle 1, for example a passenger car. The motor vehicle 1 comprises a parking assistance system 2, which is a semi-autonomous or fully automatic parking assistance system 2. The parking assistance system 2 includes a control device 3 or control unit. The control unit 3 controls a steering device 4 and, optionally, a drive and braking device 5 of the motor vehicle 1. The control device 3 can operate the steering device 4 and optionally also the drive and braking device 5 automatically in order to control a transverse guidance and longitudinal guidance of the motor vehicle 1 autonomously. The parking assistance system 2 is designed to perform an at least semi-autonomous parking operation of the motor vehicle 1 into a parking garage 20.

The parking assistance system 2 also comprises an on-board computer unit 6, which is configured for processing and evaluating sensor data. In addition, the computer unit 6 is designed to create a digital environment map of the area surrounding the vehicle 1 on the basis of the sensor data transferred. The control device 3 and the computer unit 6 may also be integrated in a common unit 7. The parking assistance system 2 comprises at least one environment sensor 8, 10, 11, 12, 13, 14, 15, which is designed to receive sensor data from the area surrounding the vehicle 1. The environment sensors 8, 10, 11, 12, 13, 14, 15 can include, for example, distance sensors, such as ultrasonic sensors 13, which are distributed over both the front and rear bumper of the vehicle 1; radar sensors 14, which are arranged, for example, in the respective corner areas of the vehicle 1; and lidar sensors 15, which are arranged, for example, behind the windscreen 9. The above-mentioned environment sensors 8, 10, 11, 12, 13, 14, 15 are coupled with the computer unit 6, so that the computer unit 6 can process the sensor data from these environment sensors. In addition, the environment sensors 8, 10, 11, 12, 13, 14, 15 can also comprise cameras 8, 10, 11, 12. In the exemplary embodiment 8 a camera is positioned behind the windscreen 9 of the motor vehicle 1 and captures a region of the environment in front of the motor vehicle 1. A second camera 10 is arranged in the rear section of the motor vehicle 1, for example behind the rear windscreen or else on the tailgate, which captures the environment area behind the vehicle 1. Optionally, cameras 11, 12 can also be integrated in the respective external rear-view mirrors of the motor vehicle 1. All cameras 8, 10, 11, 12 provide images of their respective surrounding area and transmit the captured images to the computer unit 6.

By means of the sensor data which are transmitted to the computer unit 6 a digital environment map of the surrounding area is created. From the digital environment map, a parking space-like subregion 21 of the surrounding area is detected by means of the computer unit 6. The parking space-like subregion 21 is then classified as a garage parking space by means of deep learning models. The deep learning models can be integrated in the computer unit in the form of deep neural networks (DNN).

In addition, in order to improve the detection of a garage parking space of a garage a receiver of position signals 17 is provided. The combination of the environment sensor data and the digital environment map of the surrounding area with position data has the advantage that it is then possible to ensure that the recognised parking space-like subregion belongs to a garage 20 and not to another type of parking space. The receiver of position signals 17 can receive, for example, signals from the well-known satellite navigation systems such as GPS, Galileo, GLONASS or Beidou.

A further improvement in the detection of a garage parking space in a garage is carried out by means of a vehicle-to-infrastructure communication. This enables the vehicle 1, in particular the parking assistance system 2, to communicate directly with the garage 20 via a corresponding data connection and identify the garage 20 as such.

FIG. 2 shows a building 18 with a garage 20, or its garage entrance. The garage 20 is bounded directly by three edges, namely by two vertical edges and one horizontal edge. While the vertical edges bound the garage entrance laterally to the left and to the right, the entrance to the garage is bounded from above by the horizontal edge. The sensor data received from the sensors 8, 10, 11, 12, 13, 14, 15 is converted in the computer unit 6 into a digital environment map 21, which contains the layout of the garage 20, shown in FIG. 2 by the dashed lines. The parking space-like subregion of the garage 20 is detected, however the system cannot ensure that the garage layout provided and the parking space-like sub-region detected therein also relates to a garage parking space. This is due to the fact that a similar interpretation can be obtained in the case of a parking space which is suitable for right-angled parking. The parking space-like subregion is therefore further classified as a garage parking space by means of deep learning models. In addition, a vehicle-to-infrastructure antenna 19 is shown, which can provide a data connection between the vehicle 1 and the garage 20 by means of a vehicle-to-infrastructure communication.

FIG. 3 now shows a parking scenario in which the motor vehicle 1 is situated in a starting position I. In the starting position I the parking assistance system 2 receives sensor data using at least one environment sensor 8, 10, 11, 12, 13, 14, 15 from the surrounding area and sends the sensor data to the on-board computer unit 6. The computer unit 6 creates a digital map of the environment map of the surrounding area from the sensor data. Since the parking space-like subregion 21 from the digital environment map and therefore the layout of the garage 20 can also correspond to a layout of a parking space which is suitable for right-angled parking, the parking space-like subregion is classified using deep learning models as a garage 20. This will ensure that the object is in fact a garage 20 and not a parking space. In the case of a parking space-like subregion 21 which has already been classified as a garage 20, the computer unit 6 calculates a parking trajectory from the current starting position I to an intermediate position II between the starting position I and a target position III in the garage 20. The motor vehicle 1 is then driven semi-autonomously or fully automatically into the intermediate position II along the determined parking trajectory. In doing so the control device 3 operates at least the steering device 4 and optionally also the drive and braking device 5. Any obstacles 22 present are also detected by the environment sensors 8, 10, 11, 12, 13, 14, 15 and classified using the deep learning models. This improves the safety of the parking operation.

FIG. 4 shows a simplified schematic flow diagram of an embodiment of a method according to the invention. In step S1 sensor data are received using the parking assistance system 2 from the at least one environment sensor 8, 10, 11, 12, 13, 14, 15 from the area surrounding the motor vehicle 1, and in step S2 the data are transmitted to an on-board computer unit 6.

In step S3, the computer unit 6 creates a digital environment map of the surrounding area from the sensor data. In step S4, a parking space-like subregion 21 of the surrounding area is detected in the environment map. In step S5, the parking space-like subregion 21 is classified as a garage parking space of a garage 20 by means of deep learning models. The deep learning models used can comprise neural networks, in particular deep neural networks (DNN).

Since the environment sensors 8, 10, 11, 12, 13, 14, 15 supply a large quantity of data, in step S5 a model for the garage parking space is used and missing parameters in the model are supplemented by means of the sensor data. For this purpose, the deep learning model is pre-trained for the classification of garage parking spaces, wherein the pre-training of the deep learning model is carried out by accessing data from a database or by on-board recording of sensor data. The pre-training of the deep learning model can be carried out online or offline. In the online mode (“online”) the deep learning model can access data from a database, in particular cloud, which is already filled with sensor data that has been sent to the database, for example a cloud, by other vehicles, for example by development vehicles, via a mobile network. The actual learning process of the deep learning model after the input of this sensor data can also be carried out in the offline mode (“offline”). The sensor data in this database are preferably manually tagged or annotated. The pre-training of the deep learning model can also be carried out by on-board recording of sensor data which are preferably used in the offline mode for the learning or pre-training process.

### LIST OF REFERENCE NUMERALS

1 vehicle
2 parking assistance system
3 control device
4 steering device
5 drive and braking device
6 computer unit
7 unit
8 camera
9 windscreen
10 camera
11 camera
12 camera
13 sensor
14 sensor
15 sensor
16 vehicle-to-infrastructure antenna
17 position signal receiver
18 building
19 antenna
20 garage
21 parking space-like subregion
22 obstacle

1. A method for detecting garage parking spaces for vehicles in an area surrounding a vehicle using a parking assistance system, wherein the vehicle has at least one environment sensor, the method comprising:
reception of sensor data using the parking assistance system from the at least one environment sensor from the surrounding area;
transmission of the sensor data to an on-board computer unit;
creation of a digital map of the surrounding area from the sensor data;
detection of a parking space-like subregion of the surrounding area in the environmental snap; and
classification of the parking space-like subregion as a garage parking space by means of deep learning models.

2. The method according to claim 1, wherein a model is used for the garage parking space and missing parameters in the model are supplemented by means of the sensor data using the deep learning model, thus enabling a classification of the parking space-like subregion as a garage parking space.

3. The method according to claim 1, wherein the deep learning model is pre-trained for the classification of garage parking spaces, wherein the pre-training of the deep learning model is carried out by accessing data from a database or by on-board recording of sensor data.

4. The method according to claim 3, wherein the pre-training of the deep learning model is carried out online or offline.

5. The method according to claim 1, wherein the deep learning model comprises a neural network, in particular a deep neural network (DNN).

6. The method according to claim 1, wherein receiving sensor data with the at least one environment sensor comprises receiving environment sensor data of at least one on-board environment sensor including at least one selected from the group consisting of: in particular receiving ultrasonic sensor data, radar sensor data, and lidar data, with the parking assistance system.

7. The method according to claim 1, wherein the step of receiving sensor data with the at least one environment sensor comprises receiving image data from one or more images and/or video sequences using at least one camera system, comprising one or more cameras, with the parking assistance system.

8. The method according to claim 1, wherein the creation of a digital map of the surrounding area from the sensor data comprises creating a three-dimensional environment map.

9. The method according to claim 1, wherein the classification of the parking space-like subregion as a garage parking space comprises using a position signal.

10. The method according to claim 1, wherein for the classification of the parking space-like subregion as a garage parking space a vehicle-to-infrastructure communication is used, wherein the vehicle communicates directly with the garage.

11. The method according to claim 1, further comprising: automatically activating the parking assistance system, as soon as the parking space-like subregion has been classified as a garage parking space.

12. The method according to claim 1, wherein the parking in the garage is carried out autonomously by the parking assistance system.

13. The method according to claim 1, wherein a size of the available free space for parking in the garage is determined.

14. A parking assistance system, for a vehicle to support a driver of a motor vehicle when parking in a parking space in a garage, comprising:
at least one environment sensor which is configured for receiving sensor data from the area surrounding the vehicle; and
an on-board computer unit for receiving the sensor data and for creating a digital environment map of the surrounding area based on/using the sensor data, and for detecting a parking space-like subregion of the surrounding area in the environment map and for classifying the parking space-like subregion as a garage parking space of deep learning models.

15. A motor vehicle having a parking assistance system according to claim 14.
